(19) United States
(12) Patent Application Publication
(10) Pub. No.: US 2002/0071479 A1
(43) Pub. Date: Jun. 13, 2002

(54) Use of common waveform in forward and reverse channels to reduce cost in point-to-multipoint system and to provide point-to-point mode

(75) Inventors: Thomas R. Giallorenzi, Riverton, UT (US); Eric K. Hall, Holliday, UT (US); Richard B. Ertel, Midvale, UT (US); Philip L. Stephenson, Salt Lake City, UT (US); Dan M. Griffin, Bountiful, UT (US); Lee A. Butterfield, West Jordan, UT (US)

Correspondence Address: HARRINGTON & SMITH, LLP, 1809 BLACK ROCK TURNPIKE, FAIRFIELD, CT, 06432, US

(73) Assignee: L-3 Communications Corporation, New York, NY (US)

(21) Appl. No.: 09/829,197

(22) Filed: Apr. 9, 2001

Related U.S. Application Data
(60) Provisional application No. 60/243,980, filed on Oct. 27, 2000.

(51) Int. Cl. H04B 1/69

(52) U.S. Cl. 375/141

(57) ABSTRACT

A method and apparatus for operating a communication system having subscriber stations (SSs) and at least one base station (BS). The communication system operates in accordance with a method that includes steps of: (a) arranging the forward link and the reverse link to operate with a common waveform; and (b) using common forward link and reverse link signal processing circuitry in the BS and individual ones of the SSs. A further step provides switching circuitry for cross-connecting RF signal paths for enabling one of the SSs to function as a BS. The common waveform enables essential parameters of the forward link and the reverse link to be identical, where the essential parameters can include some or all of the following parameters: the modulation format, chip rate, symbol rate, bit rate, frame rate, superframe rate, frame structure, error control coding scheme, sync words, and control field structure. Other parameters may also be made equal between the forward link and the reverse link.

### CLAIM OF PRIORITY FROM COPENDING PROVISIONAL PATENT APPLICATION

This patent application claims priority from U.S. Provisional Patent Application No.: 60/243,980, filed on Oct. 27, 2000, the disclosure of which is incorporated by reference herein in its entirety.

### FIELD OF THE INVENTION

This invention relates generally to wireless communications systems and methods, and relates in particular to Code Division Multiple Access (CDMA) systems having forward and reverse link waveforms.

### BACKGROUND OF THE INVENTION

Cellular and fixed wireless access air-interfaces typically use different waveforms in the forward and reverse links. For example, in conventional practice different application specific integrated circuits (ASICs) are required to be developed for use in the base station and in the subscriber stations, resulting in increased cost and complexity. Furthermore, frequency division duplex systems having a low IF interface from a digital modem to an RF front end cannot use either high-side or low-side LO injection to reverse the frequency bands of the transmitter and receiver, thus requiring different hardware to be used in the base station and in the subscriber station, thereby increasing cost further.

Since systems having a cellular-like point-to-multipoint architecture always have many more subscriber stations than base stations, it is generally economically justifiable to develop custom ASICs for the subscriber stations to reduce their cost. In contrast, ASIC developments are generally too expensive to be viable for base stations. As a result, when different waveforms are used in the forward and reverse links, base stations often must employ more expensive programmable gate arrays rather than lower-cost custom ASICs.

### SUMMARY OF THE INVENTION

The inventors have realized that there are certain substantial advantages in using a common variable-rate waveform in both directions.

Disclosed herein is a method and apparatus for operating a communication system having subscriber stations (SSs) and at least one base station (BS). The method includes steps of: (a) arranging the forward link and the reverse link to operate with a common waveform; and (b) using common forward link and reverse link signal processing circuitry in the BS and individual ones of the SSs. The forward link operates at a first frequency that is transmitted by the BS and received by the SS, and the reverse link operates at a second frequency that is transmitted by the SS and received by the BS. A further step provides switching circuitry for cross-connecting RF signal paths for enabling one of the SSs 10 to function as a BS.

The common waveform enables essential parameters of the forward link and the reverse link to be the same, where the essential parameters can include some or all of the following parameters: the modulation format, chip rate, symbol rate, bit rate, frame rate, superframe rate, frame structure, error control coding scheme, synchronization (sync) words, and control field structure. Other parameters may also be made equal between the forward link and the reverse link.

The switching circuitry for cross-connecting RF signal paths enables an SS to function as a BS by transmitting on the first frequency and receiving on the second frequency, where the SS functions as one of a point-to-multipoint pseudo-BS for at least transmitting signals to a plurality of other SSs, or as a point-to-point pseudo-BS for transmitting signals to and receiving signals from another SS.

### BRIEF DESCRIPTION OF THE DRAWINGS

The above set forth and other features of the invention are made more apparent in the ensuing Detailed Description of the Invention when read in conjunction with the attached Drawings, wherein:

FIG. 1 is simplified block diagram of a wireless access reference model that pertains to the teachings of this invention;

FIG. 2 is block diagram of a physical (PHY) system reference model showing a major data flow path;

FIG. 3 shows an Error Control Coding (ECC) and scrambling technique for single CDMA channel;

FIG. 4 is a Table illustrating exemplary parameters for a 3.5 MHz RF channelization;

FIG. 5 is a Table depicting an aggregate capacity and modulation factors versus modulation type and array size;

FIG. 6 is a block diagram of an exemplary subscriber unit mode, with the transmitter on 2000 MHz (reverse link) and the receiver on 2100 MHz (forward link), the subscriber unit using a common forward and reverse link waveform;

FIG. 7 is a block diagram of a corresponding base station mode, with the transmitter on 2100 MHz (forward link) and the receiver on 2000 MHz (reverse link), where the base station also uses the common forward and reverse link waveform; and

FIGS. 8A and 8B illustrate the use of a subscriber station (SS) operating in a pseudobase station (BS) mode in a point-to-multipoint and a point-to-point configuration, respectively.

### DETAILED DESCRIPTION OF THE INVENTION

Disclosed herein is a PHY system intended for IEEE 802.16.3 and related standards, although those having skill in the art should realize that various aspects of these teachings have wider applicability.

The technique is based on a hybrid synchronous DS-CDMA (S-CDMA) and FDMA scheme using quadrature amplitude modulation (QAM) and trellis coding. For a general background and benefits of S-CDMA with trellis-coded QAM one may refer to R. De Gaudenzi, C. Elia and R. Viola, “Bandlimited Quasi-Synchronous CDMA: A Novel Satellite Access Technique for Mobile and Personal Communication Systems,” IEEE Journal on Selected Areas in Communications, Vol. 10, No. 2, February 1992, pp. 328-343, and to R. De Gaudenzi and F. Gianneti, “Analysis and Performance Evaluation of Synchronous Trellis-Coded CDMA for Satellite Applications,” IEEE Transactions on Communications, Vol. 43, No. 2/3/4, February/March/April 1995, pp. 1400-1409.

The ensuing description focuses on a frequency division duplexing (FDD) mode. While a time division duplexing (TDD) mode is also within the scope of these teachings, the TDD mode is not discussed further.

What follows is an overview of the PHY teachings in accordance with this invention.

The system provides synchronous direct-sequence code division multiple access (DS-CDMA) for both upstream and downstream transmissions. The system further provides spread RF channel bandwidths from 1.75-7 MHz, depending on target frequency band, and a constant chip rate from 1-6 Mcps (Million chips per second) within each RF sub-channel with common I-Q spreading. The chip rate depends on channelization of interest (e.g. 3.5 MHz or 6 MHz). The system features orthogonal, variable-length spreading codes using Walsh-Hadamard designs with spread factors (SF) of 1, 2, 4, 8, 16, 32, 64 and 128 chips/symbol being supported, and also features unique spreading code sets for adjacent, same-frequency cells/sectors. Upstream and downstream power control and upstream link timing control are provided, as are single CDMA channel data rates from 32 kbps up to 16 Mbps depending on SF (spreading factor) and chip rate. In the preferred system S-CDMA channel aggregation is provided for the highest data rates.

Furthermore, in the presently preferred embodiment FDMA is employed for large bandwidth allocations with S-CDMA in each FDMA sub-channel, and S-CDMA/FDMA channel aggregation is used for the higher data rates. Code, frequency and/or time division multiplexing is employed for both upstream and downstream transmissions. Frequency division duplex (FDD) or time division duplex (TDD) can be employed, although as stated above the TDD mode of operation is not described further. The system features coherent QPSK and 16-QAM modulation with optional support for 64-QAM. End-to-end raised-cosine Nyquist pulse shape filtering is employed, as is adaptive coding, using high-rate punctured, convolutional coding (K=7) and/or Turbo coding (rates of 4/5, 5/6 and 7/8 are typical). Data randomization using spreading code sequences is employed, as is linear equalization in the downstream with possible transmit pre-equalization for the upstream. Also featured is the use of space division multiple access (SDMA) using adaptive beam-forming antenna arrays (1 to 16 elements possible) at the base station.

FIG. 1 shows the wireless access reference model per the IEEE 802.16.3 FRD (see IEEE 802.16.3-00/02r4, “Functional Requirements for the 802.16.3 Interoperability Standard.”). Within this model, the PHY technique in accordance with these teachings provides access between one or more subscriber stations (SS) 10 and base stations 11 to support the user equipment 12 and core network 14 interface requirements. An optional repeater 16 may be deployed.

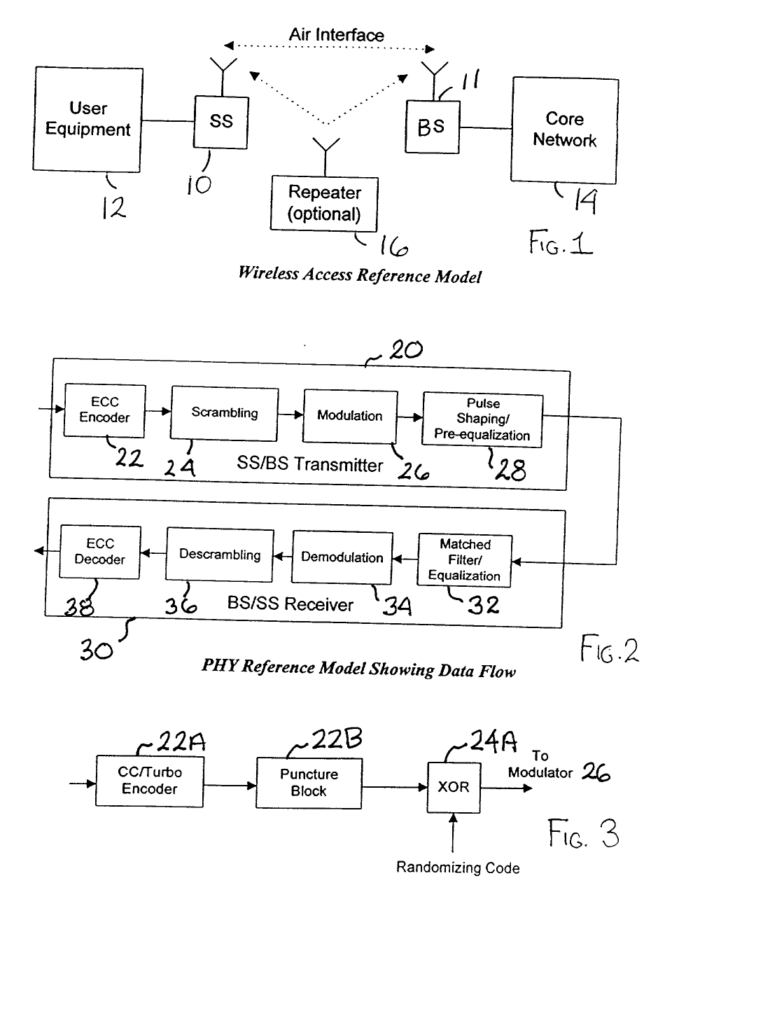

In FIG. 2, the PHY reference model is shown. This reference model is useful in discussing the various aspects of the PHY technique. As is apparent, the SS 10 and BS transmission and reception equipment may be symmetrical. In a transmitter 20 of the BS 11 or the SS 10 there is an Error Control Coding (ECC) encoder 22 for incoming data, followed by a scrambling block 24, a modulation block 26 and a pulse shaping/pre-equalization block 28. In a receiver 30 of the BS 11 or the SS 10 there is a matched filter/equalization block 32, a demodulation block 34, a descrambling block 36 and an ECC decoder 38. These various components are discussed in further detail below.

The PHY interfaces with the Media Access Control (MAC) layer, carrying MAC packets and enabling MAC functions based on Quality of Service (QoS) requirements and Service Level Agreements (SLAs). As a S-CDMA system, the PHY interacts with the MAC for purposes of power and timing control. Both power and timing control originate from the BS 11, with feedback from the SS 10 needed for forward link power control. The PHY also interacts with the MAC for link adaptation (e.g. bandwidth allocation and SLAs), allowing adaptation of modulation formats, coding, data multiplexing, etc.

With regard to frequency bands and RF channel bandwidths, the primary frequency bands of interest for the PHY include the ETSI frequency bands from 1-3 GHz and 3-11 GHz as described in ETSI EN 301 055, Fixed Radio Systems; Point-to-multipoint equipment; Direct Sequence Code Division Multiple Access (DS-CDMA); Point-to-point digital radio in frequency bands in the range 1 GHz to 3 GHz, and in ETSI EN 301 124, Transmission and Multiplexing (TM); Digital Radio Relay Systems (DRRS); Direct Sequence Code Division Multiple Access (DS-CDMA) point-to-multipoint DRRS in frequency bands in the range 3 GHz to 11 GHz, as well as with the MMDS/MDS (digital TV) frequency bands. In ETSI EN 301 124, the radio specifications for DS-CDMA systems in the fixed frequency bands around 1.5, 2.2, 2.4 and 2.6 GHz are given, allowing channelizations of 3.5, 7, 10.5 and 14 MHz. Here, the Frequency Division Duplex (FDD) separation is specific to the center frequency and ranges from 54 to 175 MHz. In ETSI EN 301 124, Transmission and Multiplexing (TM); Digital Radio Relay Systems (DRRS); Direct Sequence Code Division Multiple Access (DS-CDMA) point-to-multipoint DRRS in frequency bands in the range 3 GHz to 11 GHz., the radio characteristics of DS-CDMA systems with fixed frequency bands centered around 3.5, 3.7 and 10.2 GHz are specified, allowing channelizations of 3.5, 7, 14, 5, 10 and 15 MHz. Here, FDD separation is frequency band dependant and ranges from 50 to 200 MHz. Also of interest to these teachings are the MMDS/ITSF frequency bands between 2.5 and 2.7 GHz with 6 MHz channelizations.

With regard to multiple access, duplexing and multiplexing, the teachings herein provide a frequency division duplex (FDD) PHY using a hybrid S-CDMA/FDMA multiple access scheme with SDMA for increased spectral efficiency. In this approach, a FDMA sub-channel has an RF channel bandwidth from 1.75 to 7 MHz. The choice of FDMA sub-channel RF channel bandwidth is dependent on the frequency band of interest, with 3.5 MHz and 6 MHz being typical per the IEEE 802.16.3 FRD. Within each FDMA sub-channel, S-CDMA is used with those users transmitting in the upstream and downstream using a constant chipping rate from 1 to 6 Mchips/second. While TDD could be used in a single RF sub-channel, this discussion is focused on the FDD mode of operation. Here, FDMA sub-channel(s) are used in the downstream while at least one FDMA sub-channel is required for the upstream. The approach is flexible to asymmetric data traffic, allowing more downstream FDMA sub-channels than upstream FDMA sub-channels when traffic patterns and frequency allocation warrant. Based on existing frequency bands, typical upstream/downstream FDMA channel separation range from 50 to 200 MHz.

Turning now to the Synchronous DS-CDMA (S-CDMA) aspects of these teachings, within each FDMA sub-channel, S-CDMA is used in both the upstream and the downstream directions. The chipping rate is constant for all SS with rates ranging from 1 to 6 Mchips/second depending on the FDMA RF channel bandwidth. Common I-Q spreading is performed using orthogonal, variable-length spreading codes based on Walsh-Hadamard designs with spread factors ranging from 1 up to 128 chips per symbol (see, for example, E. Dinan and G. Jabbari, “Spreading Codes for Direct Sequence CDMA and Wideband CDMA Cellular Networks,” IEEE Communications Magazine, September 1998, pp. 48-54. For multi-cell deployments with low frequency reuse, unique spreading code sets are used in adjacent cells to minimize interference.

As will be discussed in further detail below, it should be noted that an aspect of these teachings is a symmetric waveform within each FDMA sub-channel, where both the upstream and downstream utilize the same chipping rate (and RF channel bandwidth), spreading code sets, modulation, channel coding, pulse shape filtering, etc.

Referring now to Code and Time Division Multiplexing and channel aggregation, with a hybrid S-CDMA/FDMA system it is possible to multiplex data over codes and frequency sub-channels. Furthermore, for a given code or frequency channel, time division multiplexing could also be employed. In the preferred approach, the following multiplexing scheme is employed.

For the downstream transmission with a single FDMA sub-channel, the channel bandwidth (i.e. capacity measured in bits/second) is partitioned into a single TDM pipe and multiple CDM pipes. The TDM pipe may be created via the aggregation of multiple S-CDMA channels. The purpose of this partition is based on the desire to provide Quality of Service (QoS). Within the bandwidth partition, the TDM pipe would be used for best effort service (BES) and for some assured forwarding (AF) traffic. The CDM channels would be used for expedited forwarding (EF) services, such as VoIP connections or other stream applications, where the data rate of the CDM channel is matched to the bandwidth requirement of the service.

The downlink could be configured as a single TDM pipe. In this case a time slot assignment may be employed for bandwidth reservation, with typical slot sizes ranging from 4-16 ms in length. While a pure TDM downlink is possible in this approach, it is preferred instead to employ a mixed TDM(CDM approach. This is so because long packets can induce jitter into EF services in a pure TDM link. Having CDMA channels (single or aggregated) dedicated to a single EF service (or user) reduces jitter without the need for packet fragmentation and reassembly. Furthermore, these essentially “circuit-switched” CDM channels would enable better support of legacy circuit-switched voice communications equipment and public switched telephone networks.

For the upstream, the preferred embodiment employs a similar partition of TDM/CMD channels. The TDM channel(s) would be used for random access, using a slotted-Aloha protocol. In keeping with a symmetric waveform, recommended burst lengths are on the order of the slot times for the downlink, ranging from 4-16 ms. Multi-slot bursts are possible. The BS 11 monitors bursts from the SS 10 and allocates CDMA channels to SSs upon recognition of impending bandwidth requirements or based on service level agreements (SLAs). As an example, a BS 11 recognizing the initiation of a VoIP connection could move the transmission to a dedicated CDMA channel with a channel bandwidth of 32 kbps.

When multiple FDMA sub-channels are present in the upstream or downstream directions, similar partitioning could be used. Here, additional bandwidth exists which implies that more channel aggregation is possible. With a single TDM channel, data may be multiplexed across CDMA codes and across frequency sub-channels.

With regard now to Space Division Multiple Access (SDMA) extensions, a further aspect of this multiple access scheme involves the use of SDMA using adaptive beamforming antennas. Reference can be made to J. Liberti and T. Rappaport, Smart Antennas for Wireless CDMA, Prentice-Hall PTR, Upper Saddle River, N.J., 1997, for details of beamforming with CDMA systems.

In accordance with the teachings herein there is provided an adaptive antenna array at the BS 11, with fixed beam SS antennas. In this approach, S-CDMA/FDMA channels can be directed at individual SSs. The isolation provided by the beamforming allows the CDMA spreading codes to be reused within the same cell, greatly increasing spectral efficiency. Beamforming is best suited to CDM rather than TDM channels. In the downstream, TDM would employ beamforming on a per slot or burst basis, increasing complexity. In the upstream, beamforming would be difficult since the BS 11 would need to anticipate transmission from the SS in order to form the beams appropriately. In either case, reuse of CDMA spreading codes in a TDM-only environment would be difficult. With CDM, however, the BS 11 may allocate bandwidth (i.e. CDMA channels) to SS 10 based on need, or on SLAs. Once allocated, the BS 11 forms a beam to the SS 10 to maximize signal-to-interference ratios. Once the beam is formed, the BS 11 may allocate the same CDMA channel to one or more other SSs in the cell. It is theoretically possible for the spectral efficiency of the cell to scale linearly with the number of antennas in the BS array.

SDMA greatly favors the approach of “fast circuit-switching” over pure, TDM packet-switching in a CDMA environment. By “fast circuit-switching”, what is implied is that packet data services are handled using dedicated connections, which are allocated and terminated based on bandwidth requirements and/or SLAS. An important consideration when providing effective packet-services using this approach lies in the ability of the BS 11 to rapidly determine bandwidth needs, and to both allocate and terminate connections rapidly. With fast channel allocation and termination, SDMA combined with the low frequency reuse offered by S-CDMA is a preferred option, in terms of spectral efficiency, for FWA applications.

A discussion is now made of waveform specifications. The waveform includes the channel coding 22, scrambling 24, modulation 26 and pulse shaping and equalization functions 28 of the air interface, as depicted in FIG. 2. Also included are waveform control functions, including power and timing control. In the presently preferred PHY, each CDMA channel (i.e. spreading code) uses a common waveform, with the spreading factor dictating the data rate of the channel.

With regard to the Error Control Coding (ECC) function 22 of FIG. 2, the ECC is preferably high-rate and adaptive. High rate codes are used to maximize the spectral efficiency of BWA systems using S-CDMA systems that are code-limited. In code-limited systems, the capacity is limited by the code set cardinality rather than the level of the multi-user interference. Adaptive coding is preferred in order to improve performance in multipath fading environments. For the coding options, and referring as well to FIG. 3, the baseline code is preferably a punctured convolutional code (CC). The constituent code may be the industry standard, rate ½, constraint length 7 code with generator (133/171)_{g}. Puncturing is used to increase the rate of the code, with rates of 3/4, 4/5, 5/6 or 7/8 supported using optimum free distance puncturing patterns. The puncturing rate of the code may be adaptive to mitigate fading conditions. For decoding (block 38 of FIG. 2), a Viterbi decoder is preferred. Reference in this regard can be made again to the above-noted publication R. De Gaudenzi and F. Gianneti, “Analysis and Performance Evaluation of Synchronous Trellis-Coded CDMA for Satellite Applications,” IEEE Transactions on Communications, Vol. 43, No. 2/3/4, February/March/April 1995, pp. 1400-1409, for an analysis of trellis-coded S-CDMA.

Turbo coding, including block turbo codes and traditional parallel and serial concatenated convolutional codes, are preferably supported as an option at the rates suggested above. In FIG. 3, the CC/Turbo coding is performed in block 22A, the puncturing in block 22B, and the scrambling can be performed using an XOR 24A that receives a randomizing code.

Each CDMA channel is preferably coded independently. Independent coding of CDMA channels furthers the symmetry of the upstream and downstream waveform and enables a similar time-slot structure on each CDMA channel. The upstream and downstream waveform symmetry aids in cost reduction, as the SS 10 and BS 11 baseband hardware can be identical. The independent coding of each S-CDMA/FDMA channel is an important distinction between this approach and other multi-carrier CDMA schemes.

Randomization is preferably implemented on the coded bit stream. Rather than using a traditional randomizing circuit, it is preferred, as shown in FIG. 3, to use randomizing codes derived from the spreading sequences used by the transmitting station. Using the spreading codes allows different randomizing sequences to be used by different users, providing more robust randomization and eliminating problems with inter-user correlated data due to periodic sequences transmitted (e.g. preambles). Since the receiving station has knowledge of the spreading codes, derandomization is trivial. Randomization may be disabled on a per channel or per symbol basis. FIG. 3 thus depicts the preferred channel coding and scrambling method for a single CDMA channel.

With regard to the modulation block 26, both coherent QPSK and square 16-QAM modulation formats are preferably supported, with optional support for square 64-QAM. Using a binary channel coding technique, Gray-mapping is used for constellation bit-labeling to achieve optimum decoded performance. This combined coding and modulation scheme allows simple Viterbi decoding hardware designed for binary codes to be used. Differential detection for all modulation formats may be supported as an option. Depending on the channel coding, waveform spectral efficiencies from 1 to 6 information bits/symbol are realized.

The modulation format utilized is preferably adaptive based on the channel conditions and bandwidth requirements. Both upstream and downstream links are achievable using QPSK waveform provided adequate SNR. In environments with higher SNR, up and downstream links may utilize 16-QAM and/or 64-QAM modulation formats for increased capacity and spectral efficiency. The allowable modulation format depends on the channel conditions and the channel coding being employed on the link.

In the preferred embodiment end-to-end raised-cosine Nyquist pulse shaping is applied by block 28 of FIG. 2, using a minimum roll-off factor of 0.25. Pulse shape filtering is designed to meet relevant spectral masks, mitigate inter-symbol interference (ISI) and adjacent FDMA channel interference.

To mitigate multipath fading, a linear equalizer 32 is preferred for the downstream. Equalizer training may be accomplished using a preamble, with decision-direction used following initial training. With S-CDMA, equalizing the aggregate signal in the downlink effectively equalizes all CDMA channels. Multipath delay spread of less than 3 μs is expected for Non-Line Of Sight (NLOS) deployments using narrow-beam (10-20°) subscriber station 10 antennas (see, for example, J. Porter and J. Thweat, “Microwave Propagation Characteristics in the S Frequency Band,” Proceedings of IEEE International Conf. On Communications (ICC) 2000, New Orleans, La., USA, June 2000, and V. Erceg, et al, “A Model for the Multipath Delay Profile of Fixed Wireless Channels,” IEEE Journal on Selected Areas in Communications (JSAC), Vol. 17, No. 3, March 1999, pp. 399-410.

The low delay spread allows simple, linear equalizers with 8-16 taps that effectively equalize most channels. For the upstream, pre-equalization maybe used as an option, but requires feedback from the subscriber station 10 due to frequency division duplexing.

Timing control is required for S-CDMA. In the downstream, timing control is trivial. However, in the upstream timing control is under the direction of the BS 11. Timing control results in reduced in-cell interference levels. While infinite in-cell signal to interference ratios are theoretically possible, timing errors and reduction in code-orthogonality from pulse shape filtering allows realistic signal to in-cell interference ratios from 30-40 dB. In asynchronous DS-CDMA (A-CDMA) systems, higher in-cell interference levels exist, less out-of-cell interference can be tolerated and higher frequency reuse is needed to mitigate out-of-cell interference(see, for example, T. Rappaport, Wireless Communications: Principles and Practice, Prentice-Hall PTR, Upper Saddle River, N.J., 1996, pp. 425-431. The ability of timing-control to limit in-cell interference is an important aspect of achieving a frequency reuse of one in a S-CDMA system.

Power control is also required for S-CDMA systems. Power control acts to mitigate in-cell and out-of-cell interference while also ensuring appropriate signal levels at the SS 10 or the BS 11 to meet bit error rate (BER) requirements. For a SS 10 close to the BS 11, less transmitted power is required, while for a distant SS 10, more transmit power is required in both the up and downstream. As with timing control, power control is an important aspect of achieving a frequency reuse of one.

Turning now to a discussion of capacity, spectral efficiency and data rates, for a single, spread FDMA channel, the presently preferred S-CDMA waveform is capable of providing channel bandwidths from 1 to 16 Mbps. Using variable-length spreading codes, each CDMA channel can be configured to operate from 32 kbps (SF=128) to 16 Mbps (SF=1), with rates depending on the modulation, coding and RF channel bandwidths. With S-CDMA channel aggregation, high data rates are possible without requiring a SF of one. In general, the use of S-CDMA along with the presently preferred interference mitigation techniques enable the system to be code-limited. Note, mobile cellular A-CDMA systems are always interference-limited, resulting in lower spectral efficiency. Recall also that in code-limited systems, the capacity is limited by the code set cardinality rather than the level of the multi-user interference. In a code-limited environment, the communications channel bandwidth of the system is equal to the communications channel bandwidth of the waveform, assuming a SF of one. In the Table shown in FIG. 4 sample parameters are shown for a hypothetical system using different coded modulation schemes and assuming a code-limited DS-CDMA environment. The Table of FIG. 4 illustrates potential performance assuming a single 3.5 MHz channel in both the upstream and downstream. The numbers reported apply to both the upstream and downstream directions, meaning that upwards of 24 Mbps fall duplex is possible (12 Mbps upstream and 12 Mbps downstream). With additional FDMA RF channels or large RF channels (e.g. 6 MHz), additional communication bandwidth is possible with the same modulation factors from the Table. As an example, allocation of 14 MHz could be serviced using 4 FDMA RF channels with the parameters described in the Table of FIG. 4. At 14 MHz, peak data rates to a given SS 10 of up to 48 Mbps are achievable, with per-CDMA channel data rates scaling up from 32 kbps. The channel aggregation method in accordance with these teachings is very flexible in servicing symmetric versus asymmetric traffic, as well as for providing reserved bandwidth for QoS and SLA support.

With regard to multi-cell performance, to this point both the capacity and spectral efficiency have been discussed in the context of a single, isolated cell. In a multi-cell deployment, S-CDMA enables a true frequency reuse of one. With S-CDMA, there is no need for frequency planning, and spectral efficiency is maximized. With a frequency reuse of one, the total system spectral efficiency is equal to the modulation factor of a given cell. Comparing S-CDMA to a single carrier TDMA approach, with a typical frequency reuse of 4, TDMA systems must achieve much higher modulation factors in order to compete in terms of overall system spectral efficiency. Assuming no sectorization and a frequency reuse of one, S-CDMA systems can achieve system spectral efficiencies from 1 to 6 bps/Hz, with improvements being possible with SDMA.

While frequency reuse of one is theoretically possible for DS-CDMA, the true allowable reuse of a specific deployment is dependent on the propagation environment (path loss) and user distribution. For mobile cellular systems, it has been shown that realistic reuse factors range from 0.3 up to 0.7 for A-CDMA: factors that are still much higher than for TDMA systems. In a S-CDMA system, in-cell interference is mitigated by the orthogonal nature of the S-CDMA, implying that the dominant interference results from adjacent cells. For the fixed environments using S-CDMA, true frequency reuse of one can be achieved for most deployments using directional SS antennas and up and downstream power control to mitigate levels of adjacent cell interference. In a S-CDMA environment, true frequency reuse of one implies that a cell is code-limited, even in the presence of adjacent cell interference.

For sectorized deployments with S-CDMA, a frequency reuse of two is required to mitigate the interference contributed by users on sector boundaries. In light of this reuse issue, it is preferred to use SDMA with adaptive beamforming rather than sectorization to improve cell capacity.

Since spectral efficiency translates directly into cost, the possibility of a frequency reuse of one is an important consideration.

The use of SDMA in conjunction with S-CDMA offers the ability to dramatically increase system capacity and spectral efficiency. SDMA uses an antenna array at the BS 11 to spatially isolate same code SSs 10 in the cell. The number of times that a code may be reused within the same cell is dependent upon the number of antenna elements in the array, the array geometry, the distribution of users in the cell, the stability of the channel, and the available processing power. Theoretically, in the absence of noise, with an M element antenna array it is possible to reuse each code sequence M times, thereby increasing system capacity by a factor of M. In practice, the code reuse is slightly less than M due to implementation loss, frequency selective multipath fading, and receiver noise. Regardless, significant capacity gains are achievable with SDMA. With appropriate array geometry and careful grouping of users sharing CDMA codes, it is possible to achieve a code reuse of 0.9M or better.

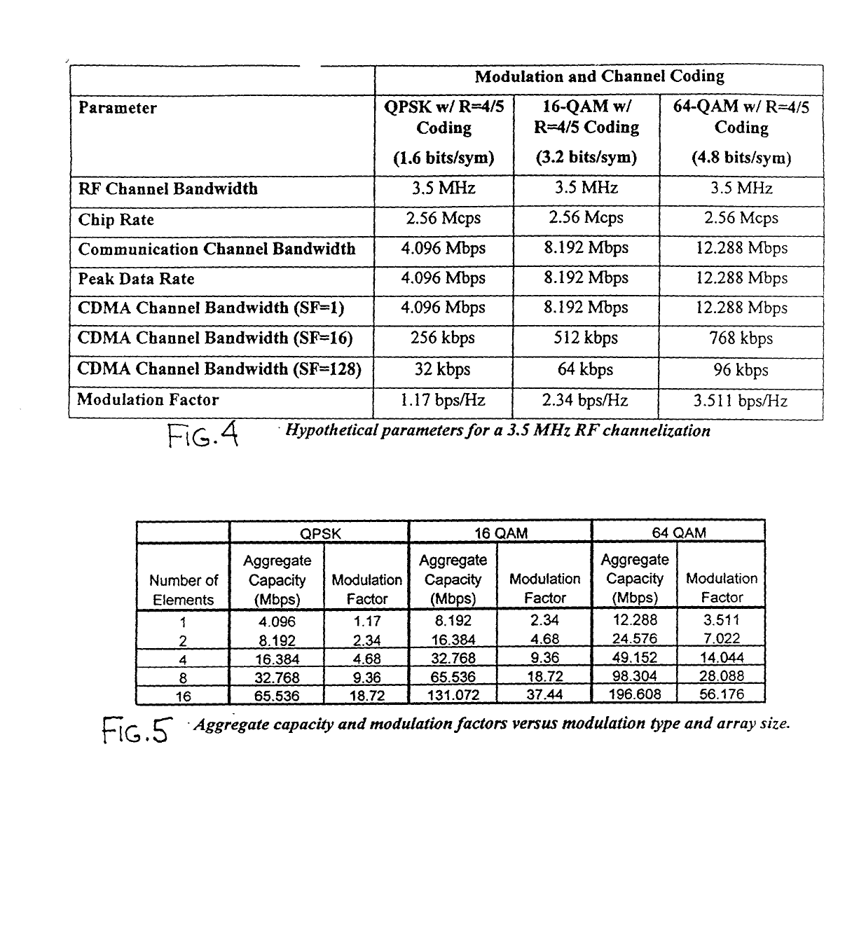

In an actual deployment the number of antenna elements is limited by the available processing power, the physical tower constraints, and system cost (e.g. the number of additional RF front ends (RFEs)). Selected array sizes vary depending upon the required capacity of the given cell on a cell-by-cell basis. The Table shown in FIG. 5 illustrates the achievable aggregate capacity and modulation factor with typical array sizes, assuming a code reuse equal to the number of antenna elements. The aggregate capacity is defined as the total data rate of the BS 11. Modulation factors exceeding 56 bps/Hz are achievable with 64 QAM and a sixteen-element antenna array. It should be noted that while SDMA increases the capacity of cell, it does not increase the peak data rate to a given SS 10.

The PHY system disclosed herein is very flexible. Using narrowband S-CDMA channels, the PHY system can adapt to frequency allocation, easily handling non-contiguous frequency allocations. The data multiplexing scheme allows great flexibility in servicing traffic asymmetry and support of traffic patterns created by higher-layer protocols such as TCP.

Deployments using the disclosed PHY are also very scalable. When traffic demands increase, new frequency allocation can be used. This involves adding additional FDMA channels, which may or may not be contiguous with the original allocation. Without additional frequency allocation, cell capacity can be increased using an adaptive antenna array and SDMA.

The high spectral efficiency of the disclosed waveform leads to cost benefits. High spectral efficiency implies less frequency bandwidth is required to provide a certain amount of capacity.

Using a symmetric waveform (i.e., a waveform that is the same in the upstream and downstream directions) is a cost saving feature, allowing the use of common baseband hardware in the SS 10 and the BS 11. The use of CDMA technology also aids in cost reduction, as some CDMA technology developed for mobile cellular applications may be applicable to gain economies of scale.

As a spread spectrum signal, the preferred waveform offers inherent robustness to interference sources. Interference sources are reduced by the spreading factor, which ranges from 1 to 128 (interference suppression of 0 to 21 dB.) At the SS 10, equalization further suppresses narrowband jammers by adaptively placing spectral nulls at the jammer frequency. Additional robustness to interference is achieved by the directionality of the SS antennas, since off-boresight interference sources are attenuated by the antenna pattern in the corresponding direction. At the BS 11, the antenna array used to implement SDMA offers the additional benefit of adaptively steering nulls towards unwanted interference sources.

The presently preferred waveform exhibits several properties that make it robust to channel impairments. The use of spread spectrum makes the waveform robust to frequency selective fading channels through the inherent suppression of inter-chip interference. Further suppression of inter-chip interference is provided by equalization at the SS 10. The waveform is also robust to flat fading channel impairments. The adaptive channel coding provides several dB of coding gain. The antenna array used to implement SDMA also functions as a diversity combiner. Assuming independent fading on each antenna element, diversity gains of M are achieved, where M is equal to the number of antenna elements in the array. Finally, since the S-CDMA system is code-limited rather than interference limited the system may run with a large amount of fade margin. Even without equalization or diversity, fade margins on the order of 10 dB are possible. Therefore, multipath fades of 10 dB or less do not increase the BER beyond the required level.

The adaptive modulation also provides some robustness to radio impairments. For receivers with larger phase noise, the QPSK modulation offers more tolerance to receiver phase noise and filter group delay. The adaptive equalizer at the SS 10 reduces the impact of linear radio impairments. Finally, the use of clipping to reduce the peak-to-average power ratio of the transmitter signal helps to avoid amplifier saturation, for a given average power output.

An important distinction between the presently preferred embodiment and a number of other CDMA approaches is the use of a synchronous upstream, which allows the frequency reuse of one. Due to some similarity with mobile cellular standards, cost savings are possible using existing, low-cost CDMA components and test equipment.

The presently preferred PHY is quite different from cable modem and xDSL industry standards, as well as existing IEEE 802.11 standards. However, with a spreading factor of one chip/symbol, the PHY supports a single-carrier QAM waveform similar to DOCSIS 1.1 and IEEE 802.16.1 draft PHY (see “Data-Over-Cable Service Interface Specifications: Radio Frequency Interface Specification”, SP-RF1v1. 1-I05-000714, and IEEE 802.16. 1-00/01r4, “Air Interface for Fixed Broadband Wireless Access Systems”, September 2000.

The presently preferred PHY technique provides an optimum choice for IEEE 802.16.3 and for other applications. An important aspect of the PHY is its spectral efficiency, as this translates directly to cost measured in cost per line or cost per carried bit for FWA systems. With a frequency reuse of one and efficient support of SDMA for increased spectral efficiency, the combination of S-CDMA with FDMA is an optimum technology for the fixed wireless access market.

Benefits of the presently preferred PHY system include:

High spectral efficiency (1-6 bps/Hz system-wide), even without SDMA;

Compatibility with smart antennas (SDMA), with system-wide spectral efficiency exceeding 20 bps/Hz possible; and

A frequency reuse of one possible (increased spectral efficiency and no frequency planning).

The use of S-CDMA provides robustness to channel impairments (e.g. multipath fading): robustness to co-channel interference (allows frequency reuse of one); and security from eavesdropping.

Also provided is bandwidth flexibility and efficiency support of QoS requirements, flexibility to support any frequency allocation using a combination of narrowband S-CDMA combined with FDMA, while adaptive coding and modulation yield robustness to channel impairments and traffic asymmetries.

The use of these teachings also enables one to leverage mobile cellular technology for reduced cost and rapid technology development and test. Furthermore, cost savings are realized using the symmetric waveform and identical SS 10 and BS 11 hardware.

Having thus described the overall PHY system, a discussion will now be provided in greater detail of an aspect thereof that is particularly pertinent to the teachings of this invention.

If the forward and reverse links of a fixed wireless access system use a common waveform, then some substantial savings can be achieved. One advantage of this approach is that the same modulators and demodulator architectures that are used in the SS 10 can also be used in the BS 11. As was noted above, systems having a cellular-like point-to-multipoint architecture always have many more SSs 10 than BSs 11. It is therefore generally economically justifiable to develop custom ASICs for the SS 10 to reduce its cost. In contrast, ASIC developments are generally too expensive to be viable for base stations. As a result, when different waveforms are used in the forward and reverse links, base stations often must employ more expensive programmable gate arrays rather than low-cost custom ASICs. In contrast, a system which employs the same waveform in the forward and reverse link will have the advantage of being able to use ASICs developed for the SS 10 in the BS 11 as well. This results in a dramatic reduction of the cost of the BS 11. For example, and referring to FIG. 2, the use of the common waveform enables many of the components (e.g., modulator, pulse shapers, matched filters, demodulator) to be implemented using common circuitry shared between the BS 11 and the SS 10.

A common waveform in the two directions implies that all of the essential parameters of the forward and reverse channel are capable of being identical. For example, the modulation format, chip rate, symbol rate, bit rate, frame rate, superframe rate, frame structure, error control coding scheme, sync words, and control field structure are preferably all capable of being the same in the forward link and the reverse link for the two waveforms to be considered common. Note that this does not require that the uplink and the downlink waveforms be identical at every point in time. For example, if the forward link is required to run at a higher rate than the reverse link to accomplish a file download to the SS 10, then the forward channel may run with a higher symbol rate and lower processing gain for some period of time than the reverse link. Thus, while the forward and reverse links may be asymmetric at any instant in time, they should still be capable of using the same waveform parameters.

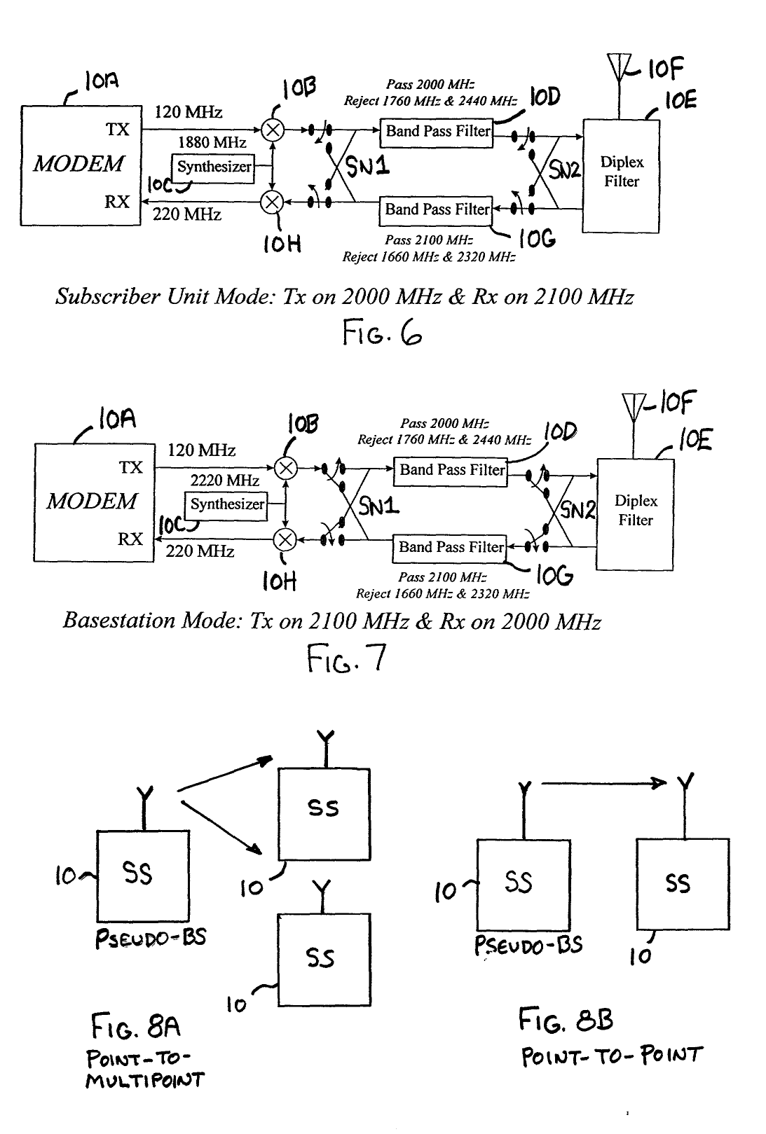

FDD systems use one frequency band for the forward link and a different frequency band for the reverse link. If the waveform is the same in the forward and reverse links, then by reversing the bands that a SS 10 transmits and receives on, the SS 10 can be made to act as a small BS 11. One simple method to reverse the transmit and receive frequencies is to use high-side versus low-side local oscillator (LO) injection and intermediate frequency (IF) sampling. For example, and referring to FIGS. 6 and 7, if a FDD system uses 2.0 GHz for the reverse link and 2.1 GHz for the forward link, then the SS 10 may be designed in the manner depicted in FIG. 6.

In FIG. 6, which shows the SS 10 operating in a subscriber unit mode, a 120 MHz modulated signal output from a transmit (TX) output of a SS 10 modem 10A is applied to a transmit mixer 10B where it is mixed with a LO frequency (e.g., 1880 MHz) output from a synthesizer 10C. The resulting frequency components pass through a first switching assembly (SN1) to a first bandpass filter 10D. The first bandpass filter 10D passes 2000 MHz and rejects 1760 MHz and 2440 MHz. The filtered transmit signal is then applied through a second switching network (SN2) to an input of a diplex filter 10E and thence to the antenna 10F of the SS 10. Signals received from the antenna 10F are output from the diplex filter 10E and pass through SN2 to a second bandpass filter 10G. The second bandpass filter 10G passes 2100 MHz and rejects 1660 MHz and 2320 MHz. The filtered received signal is then applied through SN1 to a receive mixer 10H where it is mixed with the same LO frequency (e.g., 1880 MHz) output from the synthesizer 10C. The 220 MHz frequency component of the mixed signal is then input to the modem 10A where it is demodulated.

By reprogramming the synthesizer 10C to 2220 MHz and cross-connecting the bandpass filters 10D and 10G and diplexer 10E, using SN1 and SN2 as shown, the same Radio Frequency Front End (RFFE) can thus be used as a BS 11 RFFE. Note that in FIG. 7, the same hardware as in FIG. 6 has been reconfigured to reverse the transmit and receive bands, while leaving the baseband (modem 10A) interface the same in both cases. Note also that to accomplish this, amplifiers in the RF portion of the RFFE (which are not shown) have a sufficient bandwidth to cover both the 2.0 and 2.1 GHz bands.

By employing the common forward and reverse waveform, in conjunction with RF hardware that is configurable to reverse the FDD frequencies, as shown in the example of FIGS. 6 and 7, the SS 10 can be configured to mimic the BS 11, that is, to function as a pseudo-BS as shown in FIGS. 8A and 8B. This implies that, for example, either the SS 10 can be used as a low-cost, point-to-multipoint BS 11 (FIG. 8A), or as a BS 11 imitator in a point-to-point configuration (FIG. 8B). The point-to-point configuration provides, as an example, an inexpensive method of providing leased-lines, or dedicated bandwidth to a single subscriber.

While the invention has been particularly shown and described with respect to preferred embodiments thereof, it will be understood by those skilled in the art that changes in form and details may be made therein without departing from the scope and spirit of the invention.

What is claimed is:

1. A method for operating a communication system having subscriber stations (SSs) and at least one base station (BS), comprising steps of:
arranging a forward link and a reverse link to operate with a common waveform, the forward link operating at a first frequency that is transmitted by the BS and received by the SS, and the reverse link operating at a second frequency that is transmitted by the SS and received by the BS; and
using common forward link and reverse link signal processing circuitry in the BS and individual ones of the SSs.

2. A method as in claim 1, and further comprising a step of providing switching circuitry for cross-connecting RF signal paths for enabling one of said SSs to function as a BS by transmitting on the first frequency and receiving on the second frequency.

3. A method as in claim 1, wherein said common waveform enables essential parameters of the forward link and the reverse link to be the same.

4. A method as in claim 3, wherein said essential parameters comprise a modulation format.

5. A method as in claim 3, wherein said essential parameters comprise a chip rate.

6. A method as in claim 3, wherein said essential parameters comprise a symbol rate.

7. A method as in claim 3, wherein said essential parameters comprise a bit rate.

8. A method as in claim 3, wherein said essential parameters comprise a frame rate.

9. A method as in claim 3, wherein said essential parameters comprise a superframe rate.

10. A method as in claim 3, wherein said essential parameters comprise a frame structure.

11. A method as in claim 3, wherein said essential parameters comprise an error control coding scheme.

12. A method as in claim 3, wherein said essential parameters comprise synchronization words.

13. A method as in claim 3, wherein said essential parameters comprise a control field structure.

14. A communication system comprising subscriber stations (SSs) and at least one base station (BS), and further comprising circuitry for causing a forward link and a reverse link to operate with a common waveform, the forward link operating at a first frequency that is transmitted by said BS and received by said SS, and the reverse link operating at a second frequency that is transmitted by said SS and received by said BS, said circuitry comprising common forward link and reverse link signal processing circuitry in said BS and in individual ones of said SSs.

15. A communication system as in claim 14, and further comprising switching circuitry for cross-connecting RF signal paths for enabling one of said SSs to function as a BS by transmitting on the first frequency and receiving on the second frequency.

16. A communication system as in claim 14, wherein said common waveform enables essential parameters of the forward link and the reverse link to the same.

17. A communication system as in claim 16, wherein said essential parameters comprise a modulation format.

18. A communication system as in claim 16, wherein said essential parameters comprise a chip rate.

19. A communication system as in claim 16, wherein said essential parameters comprise a symbol rate.

20. A communication system as in claim 16, wherein said essential parameters comprise a bit rate.

21. A communication system as in claim 16, wherein said essential parameters comprise a frame rate.

22. A communication system as in claim 16, wherein said essential parameters comprise a superframe rate.

23. A communication system as in claim 16, wherein said essential parameters comprise a frame structure.

24. A communication system as in claim 16, wherein said essential parameters comprise an error control coding scheme.

25. A communication system as in claim 16, wherein said essential parameters comprise synchronization words.

26. A communication system as in claim 16, wherein said essential parameters comprise a control field structure.

27. A synchronous code divisional multiple access (S-CDMA) communication system comprising subscriber stations (SSs) and at least one base station (BS), and further comprising circuitry for causing a forward link and a reverse link to operate with a common waveform, the forward link operating at a first frequency that is transmitted by said BS and received by said SS, and the reverse link operating at a second frequency that is transmitted by said SS and received by said BS, said circuitry comprising common forward link and reverse link signal processing circuitry in said BS and in individual ones of said SSs, and switching circuitry for cross-connecting RF signal paths for enabling one of said SSs to function as a BS by transmitting on the first frequency and receiving on the second frequency, wherein said SS functions as one of a point-to-multipoint pseudo-BS for at least transmitting signals to a plurality of other SSs, or as a point-to-point pseudo-BS for transmitting signals to and receiving signals from another SS.
